(19) United States
(12) Patent Application Publication
(10) Pub. No.: US 2009/0308767 A1
(43) Pub. Date: Dec. 17, 2009

(54) UMBRELLA HOLDER FOR GOLF BAG

(76) Inventor: Thomas Edward Brydon, St. Louis, MO (US)

Correspondence Address: Patent Docket Department;Armstrong Teasdale LLP, One Metropolitan Square, Suite 2600, St. Louis, MO, 63102-2740, US

(21) Appl. No.: 12/485,705

(22) Filed: Jun. 16, 2009

Related U.S. Application Data
(60) Provisional application No. 61/073,290, filed on Jun. 17, 2008.

(51) Int. Cl. A63B 55/00; A45B 25/00; F16M 13/00

(52) U.S. Cl. 206/315.3; 248/539; 248/682; 248/534

(57) ABSTRACT

An umbrella holder for a golf bag includes an elongate tube positionable within the golf bag and having an open top end and a bottom end. The elongate tube is substantially hollow from the bottom end to the top end. The top end of the elongate tube is configured for releasably retaining an umbrella in a generally upright orientation above the golf bag. A securement device is adapted for releasably connecting the elongate tube to the golf bag with the top end of the elongate tube accessible from exterior of the bag.

### FIELD

This application claims the benefit of U.S. Provisional Application No. 61/073,290, filed Jun. 17, 2008, which is hereby incorporated by reference in its entirety.

The present invention relates generally to golf-related accessories, and more particularly to a golf bag accessory for holding an umbrella.

### BACKGROUND

Golfers often carry golf-related accessories on a golf course during a round of golf. An umbrella is often included among the golf-related accessories. Typically, the umbrella is stored inside or coupled to the outside of the golf bag such that the umbrella is readily available in the event of inclement weather.

During a round of golf, it may become desirable to open and hold the umbrella over the golf bag to protect the golf clubs against getting wet and/or over the golfer's head while walking the course or walking to the golfer's ball to hit a shot.

The golfer, however, typically cannot hit the shot while holding the umbrella, thus requiring the golfer to close the umbrella and store it inside the golf bag or couple it to the outside of the golf bag or to set the open umbrella on the ground until the shot is completed. Moreover, the golfer typically cannot stand beside the golf bag under the umbrella without bending over and with both hands free.

### SUMMARY

In one embodiment, an umbrella holder for a golf bag is provided. The umbrella holder includes an elongate tube and a securement device. The elongate tube is positionable within the golf bag and has an open top end and a bottom end. The elongate tube is substantially hollow from the bottom end to the top end. The top end of the elongate tube is configured for releasably retaining an umbrella in a generally upright orientation above the golf bag. The securement device is adapted for releasably connecting the elongate tube to the golf bag with the top end of the elongate tube accessible from exterior of the bag.

In another embodiment, an umbrella holder for a golf bag is provided. The umbrella holder includes an elongate first tube and an elongate second tube. The elongate first tube is positionable within the golf bag and has an open top end and a bottom end. The elongate first tube is substantially hollow from the bottom end to the top end. The top end of the elongate tube is configured for releasably retaining an umbrella in generally coaxial alignment with the elongate first tube and generally above the golf bag. The elongate second tube is shorter than the elongate first tube. The elongate second tube has a bottom end connected to the elongate first tube and a second, open top end. The elongate second tube extends away from the elongate first tube at an angle relative thereto. The top end of the elongate second tube is configured for releasably retaining an umbrella in generally coaxial alignment with the elongate second tube and generally above the golf bag.

In yet another embodiment, an umbrella holder for a golf bag is provided. The umbrella holder includes an elongate tube and an adaptor. The elongate tube is positionable within the golf bag and has an open top end and a bottom end. The elongate tube is substantially hollow from the bottom end to the top end. The top end of the elongate tube is configured for releasably retaining an umbrella in generally coaxial alignment with the elongate tube and generally above the golf bag. The adaptor is releasably attachable to the umbrella and configured for selective releasable securement to the top end of the elongate tube to retain the umbrella on the elongate tube in generally coaxial alignment therewith. The adaptor remains with the umbrella upon removal of the umbrella from the umbrella holder.

Other features of the invention will be in part apparent and in part pointed out hereinafter.

### BRIEF DESCRIPTION OF THE DRAWINGS

FIG. 1 is a perspective view of a golf bag, an umbrella holder, an umbrella, and a plurality of golf clubs;

FIG. 2 is a perspective view of the golf bag, the umbrella holder, the umbrella shown in FIG. 1 and a cap configured to impede rain from entering the umbrella holder;

FIG. 3A is a perspective view of the umbrella holder shown in FIG. 1 in an assembled configuration;

FIG. 3B is a perspective view of the umbrella shown in FIG. 1 in an expanded configuration;

FIG. 4A is a perspective view of an adaptor configured to couple the umbrella to the umbrella holder in an assembled configuration;

FIG. 4B is a perspective view of the adaptor shown in FIG. 4A in an expanded configuration; and

FIG. 5 is a perspective view of the golf bag, the umbrella holder, and the plurality of golf clubs shown in FIG. 1, the cap shown in FIG. 2, and a cover configured to cover the golf bag and the umbrella holder.

Corresponding reference characters indicate corresponding parts throughout the drawings.

### DETAILED DESCRIPTION

The present invention enables holding an umbrella above a golf bag to facilitate shedding water away from the golf bag.

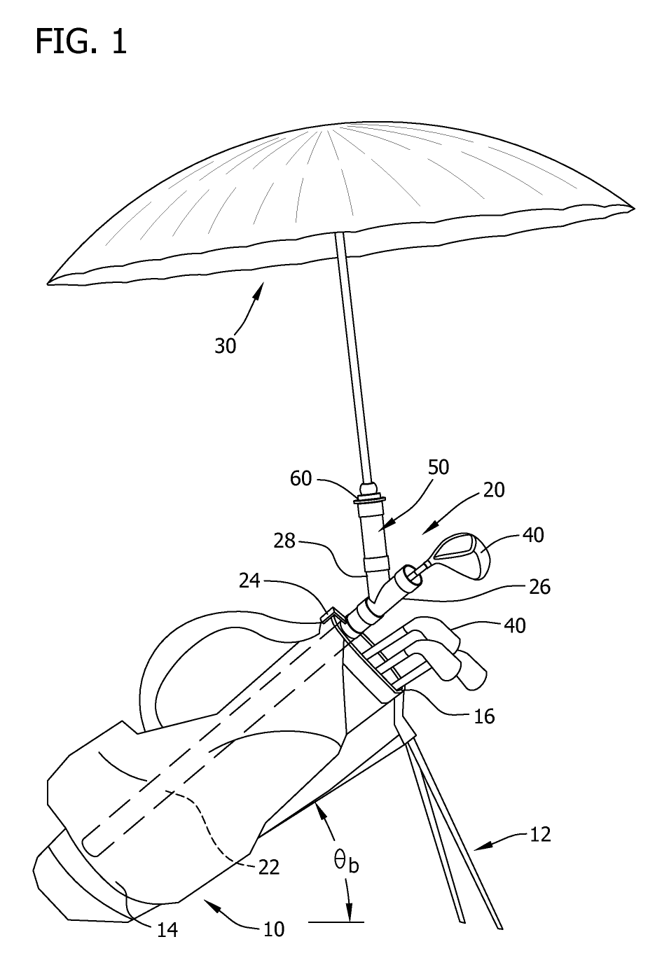

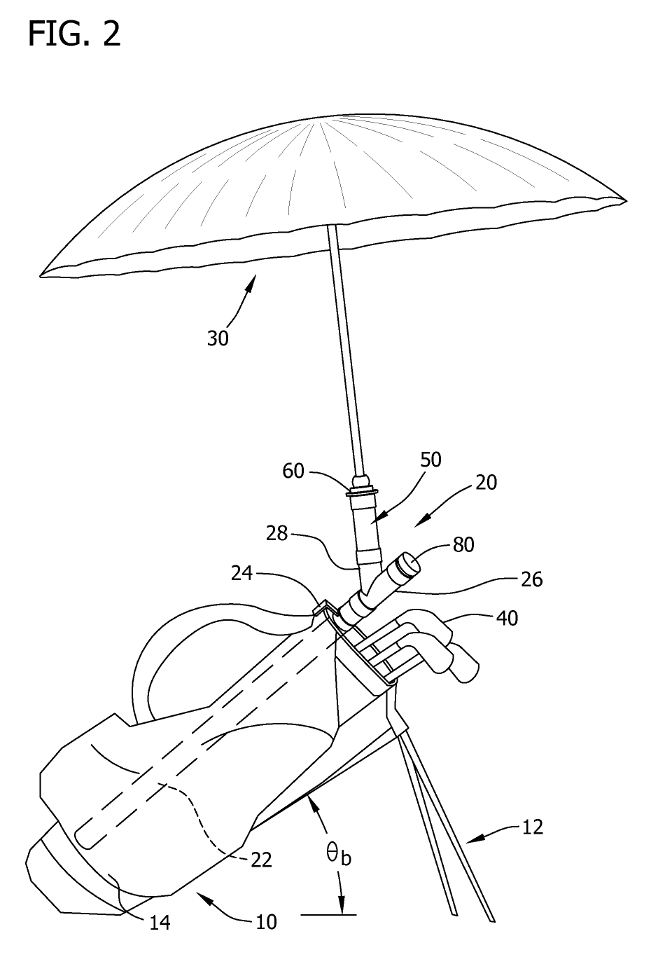

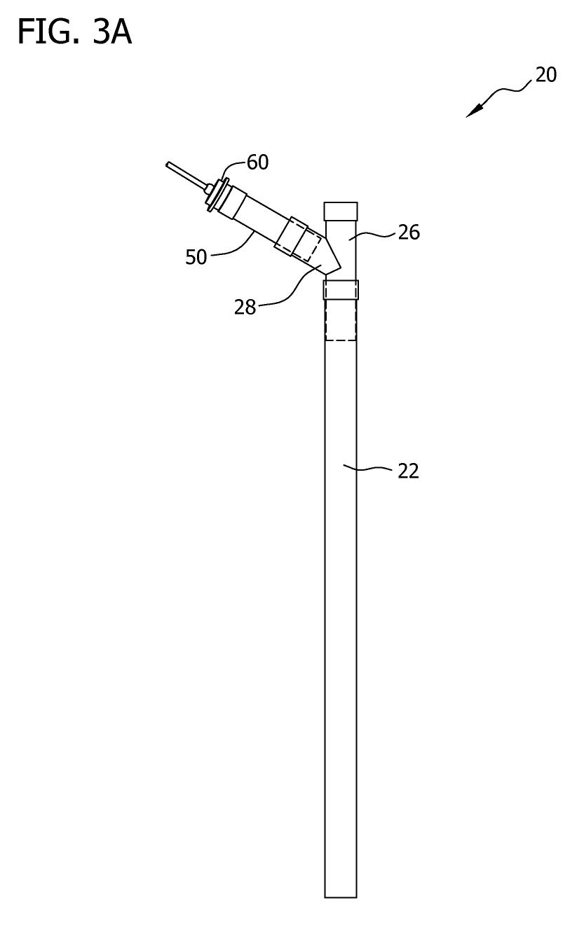

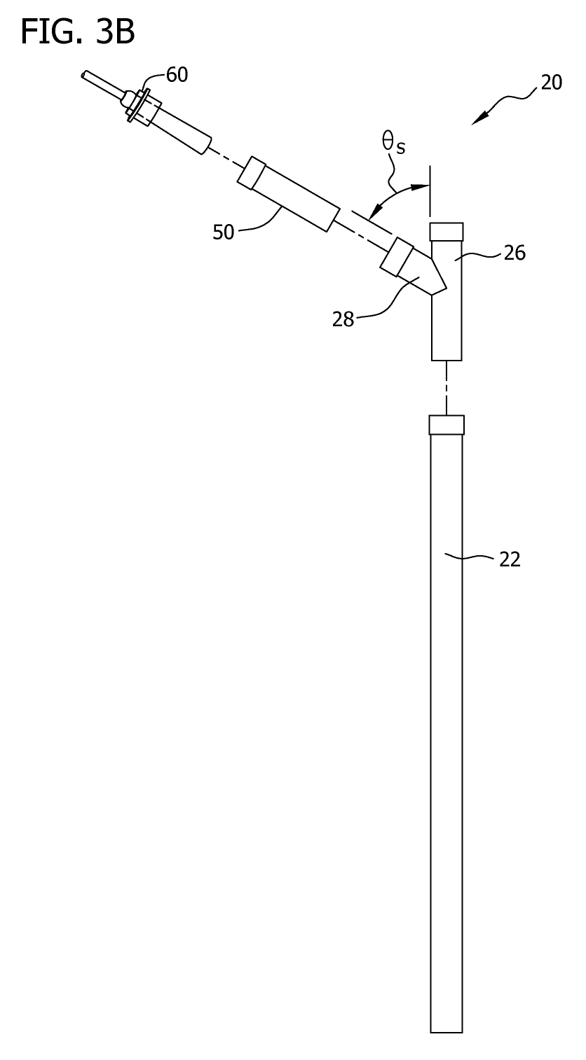

FIGS. 1 and 2 are perspective views of a golf bag 10, an umbrella holder 20, an umbrella 30, and a plurality of golf clubs 40. FIGS. 3A and 3B are perspective views of the umbrella holder 20. In the exemplary embodiment, the golf bag 10 includes a stand 12 that is configured to support the golf bag 10 at an angle Θ_{b}. The golf bag 10 includes a bottom end 14 and a top end 16 that is opposite the bottom end 14. The bottom end 14 of the golf bag 10 is closed, and the top end 16 of the golf bag 10 is open to receive a plurality of golf clubs 40.

In the exemplary embodiment, the umbrella holder 20 suitably comprises an elongate tube 22 (broadly, a first tube), a support clamp 24 (broadly, a securement device), a fitting 26, and a support member 28 (broadly, a second tube). Alternatively, any combination of the elongate tube 22, the support clamp 24, the fitting 26, and the support member 28 may be formed integrally. Moreover, any combination of the umbrella holder 20 may be formed integrally with the golf bag 10. In the exemplary embodiment, the elongate tube 22 is suitably sized in length to extend between an inner surface of the bottom end 14 to the top end 16. More specifically, in the exemplary embodiment, the elongate tube 22 extends from the inner surface of the bottom end 14 to beyond the top end 16 such that the umbrella holder 20 is visible from outside the golf bag 10. The elongate tube 22 is suitably open at the top end (i.e., the end that extends outward of the golf bag 10) and is substantially hollow from its bottom end to the top end to receive and retain the golf club 40 as described in further detail later herein.

In the exemplary embodiment, the elongate tube 22 is suitably secured to the golf bag 10 to hold the umbrella holder 20 in place within the golf bag 10. In the exemplary embodiment, the bottom end of the elongate tube 22 is positioned against the inner surface of the bottom end 14 of the golf bag 10 such that the inner surface of the bottom end 14 provides support to the umbrella holder 20. It is understood, however, that the elongate tube 22 need not extend to the inner surface of the bottom end 14 and may extend out from the top end 16 a length more than or less than that illustrated in FIG. 1 without departing from the scope of this invention.

In the exemplary embodiment, the support clamp 24 suitably secures the elongate tube 22 to the golf bag 10 such that a rotation of the elongate tube 22 is reduced. More specifically, in the exemplary embodiment, the support clamp 24 is configured to keep support member 28 at a generally upright position. In the exemplary embodiment, the support clamp 24 releasably secures the elongate tube 22 to a rim of the top end 16 to facilitate repositioning the umbrella holder 20 at any desirable position within the golf bag 10 and removing the umbrella holder 20 entirely from the golf bag 10. In the exemplary embodiment, the support clamp 24 is suitably adjustable to allow for differences in golf bag sizes and configurations. It is contemplated that any other suitable securement device(s) may be used to releasably or removably secure the umbrella holder 20 to the golf bag 10 (e.g., by screw fasteners or other devices that provide general removability from the golf bag). It is also contemplated that the elongate tube 22 may be formed integrally with, permanently secured to or otherwise incorporated into the golf bag 10 without departing from the scope of this invention.

In the exemplary embodiment, the fitting 26, which includes two open ends, is substantially coaxial with the elongate tube 22 and is configured to couple the elongate tube 22 to the support member 28. In the exemplary embodiment, the fitting 26 is also configured to receive and retain the golf club 40 as described in further detail later herein. In the exemplary embodiment, the fitting 26 is releasably connectable to the elongate tube 22 generally at the top end of the elongate tube 22. Alternatively, the fitting 26 may be formed integrally with the elongate tube 22.

In the exemplary embodiment, the top end of the elongate tube 22 has an increased diameter providing a female connector, and a bottom end of the fitting 26 has a corresponding diameter providing a male connector sized for a friction, interference, or pressure fit within the top end of the elongate tube 22 to releasably secure the fitting 26 on the elongate tube 22. It is understood, however, that the top end of the elongate tube 22 may have a diameter serving as a male connector while the bottom end of the fitting 26 has a corresponding diameter serving as a female connector. It is also contemplated that the elongate tube 22 and the fitting 26 may be configured in another suitable manner to provide a releasable connection therebetween, or that a suitable connection device separate from the elongate tube 22 and the fitting 26 may be used to releasably connect the elongate tube 22 and the fitting 26 without departing from the scope of this invention.

In the exemplary embodiment, the support member 28, which includes two open ends, extends from the fitting 26 at an angle Θₛ relative thereto. More specifically, in the exemplary embodiment, the angle Θₛ is configured such that the support member 28 extends generally vertically relative to the ground when the golf bag 10 is resting on the stand 12. As such, in the exemplary embodiment, the angle Θₛ is substantially complementary to the angle Θ_{b}. In one suitable embodiment, a securable hinge (not shown) is configured to selectively adjust the angle Θₛ to accommodate different preferences and/or different golf bag 10 angles resulting from different stand 12 heights and configurations. Other adjustable angle systems are contemplated to be within the scope of this invention.

In the exemplary embodiment, the support member 28 is formed integrally with the fitting 26. Alternatively, the support member 28 may be removably coupled to the fitting 26 via a connection similar to the top end of the elongate tube 22 and the bottom end of the fitting 26 described above.

In the exemplary embodiment, an extension tube 50, which includes two open ends, extends from the support member 28 and is configured to selectively lengthen or shorten a length of the support member 28. In one suitable embodiment, the extension tube 50 may be formed integrally with the support member 28. More specifically, in the one suitable embodiment, the extension tube 50 may be a plurality of telescoping tubes formed integrally with the support member 28. In an alternative embodiment, the extension tube 50 may be removably coupled to the support member 28 via a connection similar to the top of the elongate tube 22 and the bottom end of the fitting 26 as described above. Other extension systems are contemplated to be within the scope of this invention.

In the exemplary embodiment, the extension tube 50 is configured to support the umbrella 30 in an upright position. More specifically, in the exemplary embodiment, the extension tube 50 is configured to receive an adaptor 60 as described in further detail later herein to facilitate coupling the umbrella 30 to the umbrella holder 20.

In use, the golf bag 10 rests on the stand 12 at the angle Θ_{b}, and the umbrella holder 20 is configured to hold the umbrella 30 above the golf bag 10 to shed water away from the golf bag 10. In the exemplary embodiment, the elongate tube 22 is positionable within the golf bag 10. More specifically, the elongate tube 22 is placed down into the golf bag 10 until a bottom end of the elongate tube 22 is positioned against an inner surface of the bottom end 14, a bottom end of the fitting 26 is secured to the top end of the elongate tube 22, and a bottom end of the support member 28 is coupled to the fitting 26. To utilize the space taken up in the golf bag 10 by the elongate tube 22, the golf club 40 may be inserted—shaft first—down through the elongate tube 22 via the fitting 26.

In the exemplary embodiment, the support clamp 24 secures the elongate tube 22 to the golf bag 10 such that the support member 28 is positioned in a substantially upright position. In the exemplary embodiment, the extension tube 50 is coupled to the support member 28 and configured to adjust a height of the umbrella 30. In the exemplary embodiment, the extension tube 50 enables the golfer to insert and remove the golf club 40 without interference from the umbrella 30. More specifically, the extension tube 50 enables the golfer to adjust the height of the umbrella 30 such that the golfer may stand upright under the umbrella 30 when it is attached to umbrella holder 20. Alternatively, the elongate tube, the support member 28, and the extension tube 50 may be formed integrally such that the top end of the umbrella holder 20 is configured for releasably retaining the umbrella 30 in a generally upright orientation above the golf bag 10.

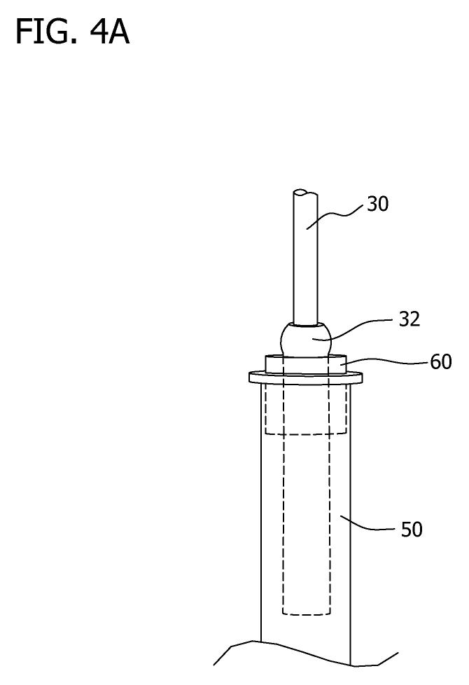

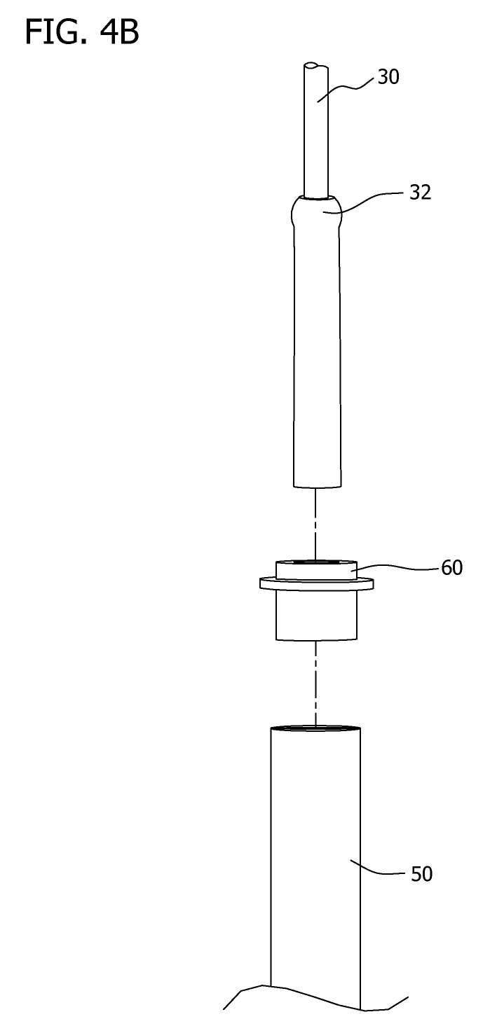

FIGS. 4A and 4B are perspective views of the extension tube 50 and the adaptor 60, which is configured to couple the umbrella 30 to the umbrella holder 20. In the exemplary embodiment, the adaptor 60 is releasably secured to a handle 32 of the umbrella 30 to facilitate coupling the umbrella 30 to the umbrella holder 20. More specifically, in the exemplary embodiment, the handle 32 is coupled to a top end of the handle 32 such that a bottom end of the handle 32 is accessible to the golfer.

In one embodiment, each of a plurality of different sized adaptors 60 is configured to facilitate housing different sized handles 32. In another embodiment, an adjustable adaptor 60, such as a clam-shell type adaptor 60 or other suitable adjustable adaptor 60, is configured to facilitate housing different sized handles 32. In yet another embodiment, the top end of the support member 28 and/or the extension tube 50 (broadly, the umbrella holder 20) has an adjustable opening that is configured to receive the handle 32 without the aid of the adaptor 60.

In the exemplary embodiment, the adaptor 60 is configured for releasable connection to the top end of the extension tube 50 via a friction, interference, or pressure fit within the top end of the extension tube 50. In the exemplary embodiment, a top end of the extension tube 50 is suitably sized substantially the same as the top end of the fitting 26 so that the adaptor 60 may be releasably connected to either the top end of the extension tube 50 or the top end of the fitting 26.

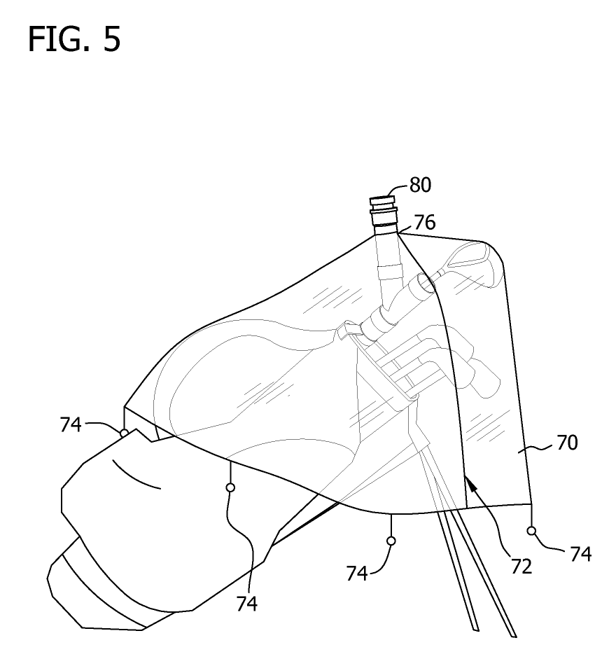

FIG. 5 is a perspective view of the golf bag 10, the umbrella holder 20, the golf clubs 40, a cover 70, and a cap 80. In the exemplary embodiment, the cover 70 is configured to cover the golf bag 10, the umbrella holder 20, and the golf clubs 40 stored in golf bag 10. More specifically, the cover 70 is sized to cover the golf bag, the umbrella holder 20, and the golf clubs 40 when the golfer removes the umbrella 30.

In the exemplary embodiment, the cover 70 includes at least one separable seam 72 and at least one weight 74. In the exemplary embodiment, the cover 70 is releasably attached to the extension tube 50 via a mechanical fastening system (shown generally at 76) such as a hook and loop fastening system. Other releasable attachment systems are contemplated to be within the scope of this invention. Alternatively, the cover 70 may be releasably coupled to any combination of the golf bag 10 and the umbrella holder 20, including any combination of the elongate tube 22, the support clamp 24, the fitting 26, the support member 28, and the extension tube 50.

In the exemplary embodiment, the seam 72 extends between the support member 28 and an outer edge of the cover 70. In the exemplary embodiment, the seam 72 is configured such that a portion of the cover 70 can be lifted to access the golf bag 10 for removing and reinserting the golf clubs 40 out of and into the golf bag 10. In the exemplary embodiment, the seam 72 is releasably openable, such as by a suitable mechanical fastening system (not shown), and, in particular, a hook and loop fastening system. In the exemplary embodiment, the cover 70 is at least one of transparent and translucent to enable the golfer to see the golf clubs 40 without moving the cover 70.

In the exemplary embodiment, the weight 74 is attached to at least one portion of the cover 70. More specifically, in the exemplary embodiment, the weight 74 is attached to a plurality of locations, wherein each of the locations are proximate an outer edge of the cover 70. In the exemplary embodiment, the weight 74 facilitates holding the outer edge of the cover 70 such that the cover 70 covers the golf bag 10 and the umbrella holder 20. The weight 74 may be any mechanism suitable for keeping the cover 70 over the golf bag 10 and the umbrella holder 20 without departing from the scope of this invention.

The cap 80 is positionable on the top end of the extension tube 50 when the adaptor 60 is removed from the extension tube 50 to facilitate impeding rain from entering the extension tube 50. The cap 80 may also be positionable on the top end of the fitting 26 or the top end of the elongate tube 22 to facilitate impeding rain from entering other openings of the umbrella holder 20.

In the exemplary embodiment, the bottom end of the cap 80 is sized for a friction, interference, or pressure fit within the top end of at least one of the elongate tube 22, the fitting 26, or the extension tube 50. It is contemplated that the cap 80 may be configured in another suitable manner to provide a releasable connection with at least one of the elongate tube 22, the fitting 26, or the extension tube 50, or that a suitable connection device may be used to releasably connect the cap 80 and the umbrella holder 20 without departing from the scope of this invention.

In use, when the golf bag 10 rests on the stand 12 at the angle Θ_{b}, the handle 32 is removably coupled to the extension tube 50 via the adaptor 60 such that the umbrella 30 is removably coupled to the golf bag 10. As such, in the exemplary embodiment, the umbrella 30 is held in a generally upright position. In this configuration, the golf club 40 is readily removable from and replaceable into the umbrella holder 20 via the top end of the fitting 26. Alternatively, when the golf bag 10 is standing upright (e.g., Θ_{b} is about 90 degrees), the golf club 40 is removed from the umbrella holder 20 and placed elsewhere in the golf bag 10 so that the handle 32 is removably coupled to the fitting 26 via the adaptor 60 such that the umbrella 30 is removably coupled to the golf bag 10. As such, in the alternative embodiment, the umbrella 30 is held in a generally upright position.

When the golfer needs to carry the golf bag 10 (such as between golf shots), the golfer simply removes the umbrella 30 (with the adaptor 60 still mounted thereon) from the umbrella holder 20 and carries the umbrella 30. Maintaining the adaptor 60 on the umbrella 30 thus allows for quick mounting and removal of the umbrella 30 to and from the umbrella holder 20 during a round of golf.

When the umbrella 30 is not needed, and storage of the umbrella holder 20 is desired, the umbrella 30 (with the adaptor 60 attached or removed as desired) is stored in its normal arrangement in the golf bag 10 (or removed from the golf bag 10 entirely). The fitting 26 may be disconnected from the elongate tube 22 and either stowed within a compartment of the golf bag 10 or stored other than with the golf bag 10. In this configuration, the elongate tube 22 may remain in and connected to the golf bag 10 so that the golf club 40 may be inserted into and retained in the elongate tube 22. Alternatively, the elongate tube 22 (and the fitting 26) may be removed entirely from the golf bag 10.

When introducing elements of the present invention or the preferred embodiment(s) thereof, the articles “a”, “an”, “the”, and “said” are intended to mean that there are one or more of the elements. The terms “comprising,” “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. An umbrella holder for a golf bag, the umbrella holder comprising:
an elongate tube positionable within the golf bag and having an open top end and a bottom end, the elongate tube being substantially hollow from the bottom end to the top end, the top end of the elongate tube being configured for releasably retaining an umbrella in a generally upright orientation above the golf bag; and
a securement device adapted for releasably connecting the elongate tube to the golf bag with the top end of the elongate tube accessible from exterior of the bag.

2. The umbrella holder of claim 1 wherein the elongate tube comprises a first tube portion and a second tube portion shorter than the first tube portion, the second tube portion having a first end connected to the first tube portion and a second open end, the second tube portion extending at an angle relative to the first tube portion, the second end of the second tube portion being configured for releasably retaining an umbrella in a generally upright orientation.

3. The umbrella holder of claim 2 wherein the second tube portion has an adjustable length.

4. The umbrella holder of claim 3 wherein the second tube portion comprises at least two tube segments that are releasably connectable in coaxial alignment with each other, the length of the second tube portion being selectively adjustable as a function of the number of tube segments used to form the second tube.

5. The umbrella holder of claim 1 comprising a generally Y-shaped fitting having a first tube portion having longitudinally opposite ends and being releasably connectable with the top end of the elongate tube in coaxial relationship with the elongate tube, and a second tube portion connected to and extending away from the first tube portion at an angle thereto, the second tube portion having an open top end distal from the connection of the second tube portion to the first tube portion, a top end of the first tube portion being configured for releasably retaining an umbrella therein in generally coaxial relationship with therewith, the top end of the second tube portion being configured for releasably retaining an umbrella therein in generally coaxial relationship therewith.

6. The umbrella holder of claim 1 further comprising an adaptor releasably attachable to the umbrella and configured for releasable securement with the top end of the elongate tube to releasably retain the umbrella above the golf bag, the adaptor remaining with the umbrella upon removal of the umbrella from the umbrella holder.

7. The umbrella holder of claim 1 wherein the securement device comprises a clamp member secured to the elongate tube and configured for clamping engagement with the golf bag.

8. The umbrella holder of claim 1 further comprising a rain cover secured to the umbrella holder and configured to extend over at least the top of the golf bag to inhibit golf clubs in the golf bag from getting wet when the umbrella is removed from the umbrella holder.

9. The umbrella holder of claim 8 wherein the rain cover is releasably connectable to the umbrella holder.

10. The umbrella holder of claim 2 further comprising a cap configured for selective removable coupling with either one of a top end of the first tube and the second end of the second tube to close the respective first and second tube when the umbrella is not retained therein.

11. The umbrella holder of claim 1 wherein the bottom end of the elongate tube is open.

12. An umbrella holder for a golf bag, the umbrella holder comprising:
an elongate first tube positionable within the golf bag and having an open top end and a bottom end, the elongate first tube being substantially hollow from the bottom end to the top end, the top end of the elongate tube being configured for releasably retaining an umbrella in generally coaxial alignment with the elongate first tube and generally above the golf bag; and
an elongate second tube shorter than the elongate first tube, the elongate second tube having a bottom end connected to the elongate first tube and a second, open top end, the elongate second tube extending away from the elongate first tube at an angle relative thereto, the top end of the elongate second tube being configured for releasably retaining an umbrella in generally coaxial alignment with the elongate second tube and generally above the golf bag.

13. The umbrella holder of claim 12 further comprising a generally Y-shaped fitting including a first tube portion having longitudinally opposite ends and being releasably connectable with the top end of the elongate first tube in coaxial relationship therewith, and a second tube portion connected to and extending away from the first tube portion at an angle thereto to define the elongate second tube, the second tube portion of the fitting having an open top end defining the open top end of the elongate second tube, a top end of the first tube portion being configured for releasably retaining an umbrella in generally coaxial relationship therewith, the top end of the second tube portion being configured for releasably retaining an umbrella in generally coaxial relationship therewith.

14. The umbrella holder of claim 12 further comprising an adaptor releasably attachable to the umbrella and configured for selective releasable securement to either one of the top end of the elongate first tube and the top end of the elongate second tube, the adaptor remaining with the umbrella upon removal of the umbrella from the umbrella holder.

15. The umbrella holder of claim 12 further comprising a rain cover secured to the umbrella holder and configured to extend over at least the top of the golf bag to inhibit golf clubs in the golf bag from getting wet when the umbrella is removed from the umbrella holder.

16. The umbrella holder of claim 15 wherein the rain cover is releasably connectable to the umbrella holder.

17. The umbrella holder of claim 12 further comprising a cap configured for selective removable coupling with either one of the top end of the elongate first tube and the top end of the elongate second tube to close the respective first and second elongate tube when the umbrella is not retained therein.

18. The umbrella holder of claim 12 wherein the bottom end of the elongate first tube is open.

19. A golf bag comprising:
an elongate tube attached to and positionable within the golf bag and having an open top end and a bottom end, the elongate tube being substantially hollow from the bottom end to the top end, the top end of the elongate tube being configured for releasably retaining an umbrella in generally coaxial alignment with the elongate tube and generally above the golf bag; and
an adaptor releasably attachable to the umbrella and configured for selective releasable securement to the top end of the elongate tube to retain the umbrella on the elongate tube in generally coaxial alignment therewith, the adaptor remaining with the umbrella upon removal of the umbrella from the umbrella holder.

20. The umbrella holder of claim 19 further comprising a cap configured for selective removable coupling with the top end of the elongate tube to close the top end of the tube when the umbrella is not retained therein.
